(19) United States
(12) Patent Application Publication
(10) Pub. No.: US 2012/0167832 A1
(43) Pub. Date: Jul. 5, 2012

(54) Maxi - play toy for dogs

(76) Inventor: Nicholas luna, Redlands, CA (US)

(21) Appl. No.: 12/930,240

(22) Filed: Dec. 31, 2010

(51) Int. Cl. A01K 29/00

(52) U.S. Cl. 119/707

(57) ABSTRACT

The present invention provides specially designed dog toys, manufactured of heavy duty, inflatable rubber material. Circular in shape, these ring-like toys are produced in three sizes, with Maxi toys measuring twelve inches, sixteen inches or twenty inches in diameter all offered for sale. Further, the rubber tubing utilized in the manufacture of the Maxi is thick and impenetrable, thus boasts a reinforced mesh liner or in other embodiments, comparable core. As such, the Maxi is designed to provide a long-lasting alternative to traditional dog toys. Positioned on the inner wall of the Maxi is a small, pinpoint valve for use in filling the device with a standard needle nozzle air hose. A simple air pump is included for sale with this toy, or in other embodiments, the Maxi is offered pre-filled.

### CLAIM OF PRIORITY

This patent application claims priority under 35 USC 119 (e) (1) from U.S. Provisional Patent Application Ser. No. 61/33,131 filed Dec. 31, 2009, of common inventorship herewith entitled, “Maxi-Play Toy for Dogs.”

### FIELD OF THE INVENTION

The present invention pertains to the field of dog toys, and more specifically to the field of rugged dog toys.

### BACKGROUND OF THE INVENTION

The prior art has put forth several designs for rugged dog toys. Among these are:

U.S. Pat. No. 5,595,142 to Michael Chill describes a therapeutic animal toy. In a preferred embodiment the toy is comprised of a hollow elongate body with outer surface ridges running parallel to the axis of the elongate body, inner surface circular ridges to effect a purchase of food held therein, wherein the elongate body is made of a flexural modulus and where the elongate body contains food such as a paste-like canned pet food.

U.S. Pat. No. 5,813,366 to William David Mauldin, Jr. describes an animal toy composed of a highly-durable, non-toxic, flexible, elastomeric, plastic, or like material, having a single or numerous gripping shaft(s) with rows of gripping splines and holding grooves that will accept and contain a variety of sizes of treats that may be endlessly replenished.

U.S. Pat. No. 6,148,771 to Charles P. Costello describes a chew article for animals that promotes dental and gingival health, oral exercise, interactive play, and reduction of problem chewing. The article includes a body of elastomeric material having an outer surface interrupted by spaced grooves. Side walls of at least some of the grooves have a corrugated surface configuration including a longitudinal ridge or ridges extending lengthwise intermediate groove depth and spaced from the outer surface of the body. An interior cavity is provided having a constricted access therein from without the body, a segment of at least some of the grooves extending through the body and into the cavity thereby defining plural laterally moveable rib portions of the body, the detached rib portions aiding maintenance of more optimal scraping orientation of the ridges when the article is in use.

None of these prior art references describe the present invention.

### SUMMARY OF THE INVENTION

It is an object of the present invention to provide a rugged dog toy.

### BRIEF DESCRIPTION OF THE DRAWINGS

FIG. 1 is an elevational angled perspective view of several embodiments of the device of the present invention.

FIG. 2 is a close-up perspective view of a portion of the device of the present invention.

FIG. 3 is an elevational angled perspective view of the device of the present invention.

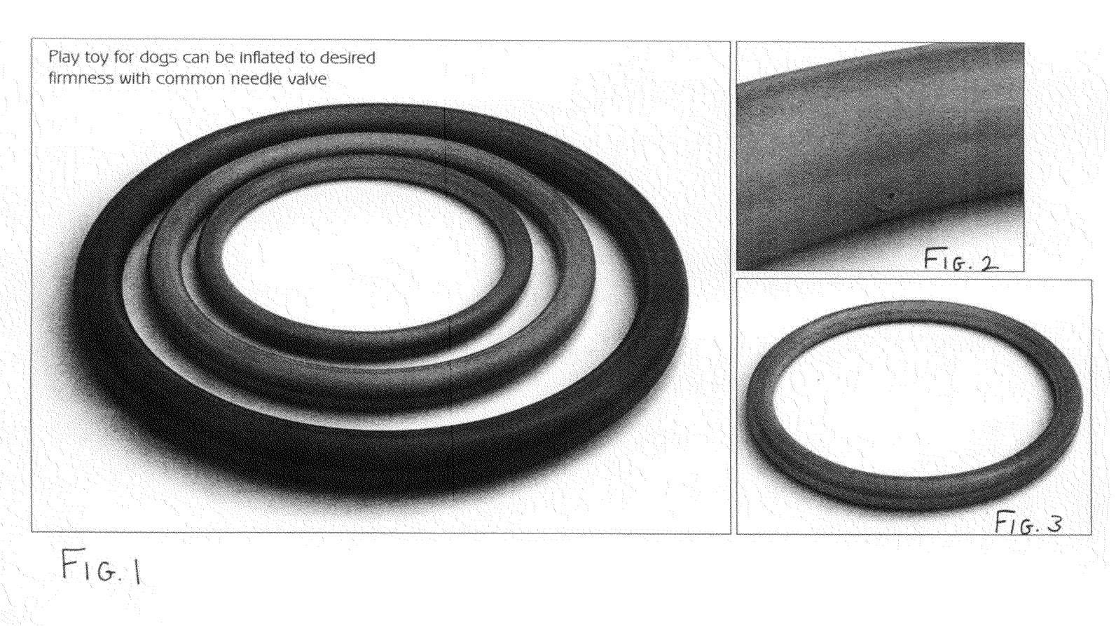

### DETAILED DESCRIPTION OF THE INVENTION

Four in ten households include a family dog. Why do so many people own dogs? The answer to that question is simple; dogs provide unconditional love, companionship and unmatched loyalty to their owners. Known as “man's best friend”, dogs offer protection and are faithful and constant friends. For many owners, a favorite end to a hectic day is spent curled up on a sofa or chair, with a beloved dog nestled nearby. Because dogs are more often considered a member of the family, as opposed to merely a pet, most owners provide adequate shelter, as well as a healthy diet for their animals. In addition, playful interaction between pet and owner is an essential tool in cementing the bond animals and humans share. From tossing a ball for the dog to retrieve or wrestling with a twine rope, these activities provide pets with amusement and warm the hearts of owners when they see their beloved companions filled with such delight. Beneficial to an animal's spirit, playing with their owners also affords pets much needed exercise and energy release.

The present invention, hereinafter referred as Maxi is a line of specially designed dog toys, manufactured of heavy duty, inflatable rubber material. Circular in shape, these ring-like toys are produced in three sizes, with Maxi toys measuring twelve inches, sixteen inches or twenty inches in diameter all offered for sale. Further, the rubber tubing utilized in the manufacture of the Maxi is thick and impenetrable, thus boasts a reinforced mesh liner or in other embodiments, comparable core. As such, the Maxi is designed to provide a long-lasting alternative to traditional dog toys. Positioned on the inner wall of the Maxi is a small, pinpoint valve for use in filling the device with a standard needle nozzle air hose. A simple air pump is included for sale with this toy, or in other embodiments, the Maxi is offered pre-filled. The Maxi is produced in various embodiments as in a myriad of vibrant colors, as well as imprinted with decorative images, including snakes, mice or other creatures.

Use and application of the Maxi is very simple and straightforward. First, the pet owner chooses one or more Maxi toys in the desired size and shape for play by their pet. By way of example, a small Maxi is offered to a toy poodle, while a brightly colored large dog toy is offered to a German Shepherd. The user may also purchase several Maxi toys, providing their canine a number of choices for play. The user then simply tosses the toy to their dog, or engages their animal in a free spirited game of tug of war or catch, via the Maxi. Quality constructed of sturdy reinforced rubber material, the Maxi withstands even the sharpened teeth of puppies, ensuring continuous and spirited play.

There are several significant benefits and advantages associated with this creative product invention. Foremost, the Maxi provides pets and their owners with a fun, interactive line of toys that they enjoy together. Specially designed pet toys manufactured of reinforced rubber tubing, the Maxi provides a sturdy alternative to traditional toys which are quickly destroyed by an enthusiastic pooch. Produced in an endless myriad of colors and patterns, the Maxi offers a simple, yet intriguing means of entertaining a beloved dog. In this manner, household pets are amused for hours, while the toy stays sturdy, strong and maintains its structural integrity. This durable line of toys also serves to entertain dogs when left home alone, helping them not to feel so lonely and thereby preventing them from tearing or ripping furniture and other valuables. In addition, pet owners surely delight in watching their companions scramble after the Maxi, as the animals' tenacious and frenzied attempts to rip the sturdy toy apart inspire laughter and merriment. Made of durable, high quality recycled materials and components, the Maxi provides an environmentally friendly product which withstands years of continued use.

An innovative product invention, the Maxi offers an invaluable tool for pet and owner playtime. Encouraging a healthy body as well as spirit for the pet, this interactive toy provides both mental and physical stimulation.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A rugged dog toy, comprising a ring-shaped device made of heavy duty, inflatable impenetrable rubber material, wherein the device further comprises a reinforced mesh liner core; and wherein a pinpoint valve for use in inflating the device is positioned on the inner wall of the device.

2. The dog toy of claim 1, wherein the diameter is approximately twelve inches.

3. The dog toy of claim 1, wherein the diameter is approximately sixteen inches.

4. The dog toy of claim 1, wherein the diameter is approximately twenty inches.

5. A dog toy kit comprising a rugged dog toy, comprising a ring-shaped device made of heavy duty, inflatable impenetrable rubber material, wherein the device further comprises a reinforced mesh liner core, and wherein a pinpoint valve for use in inflating the device is positioned on the inner wall of the device; and an air pump.

6. The dog toy of claim 1 which is pre-filled with air.
